(19) United States
(12) Patent Application Publication
(10) Pub. No.: US 2024/0407324 A1
(43) Pub. Date: Dec. 12, 2024

(54) HIDEAWAY STEPS

(71) Applicant: Mary Collins Wynn, Mulberry, FL (US)

(72) Inventor: Mary Collins Wynn, Mulberry, FL (US)

(21) Appl. No.: 18/401,929

(22) Filed: Jan. 2, 2024

Related U.S. Application Data
(60) Provisional application No. 63/421,529, filed on Nov. 1, 2022.

(51) Int. Cl. A01K 1/035

(52) U.S. Cl. CPC A01K 1/035

(57) ABSTRACT

A hideaway stair assembly is disclosed, including a housing and a plurality of steps at least partially retained within the housing in a retracted configuration and the plurality of steps at least partially extended from the housing in an extended configuration. The plurality of steps are coupled to a shaft coupled to a flexible shaft coupling. A motor drives the shaft and moves the plurality of steps between the retracted configuration and the extended configuration to allow convenient access to a furniture item by a pet.

### CROSS-REFERENCE TO RELATED APPLICATION

This application claims the benefit of U.S. Provisional Application No. 63/421,529 filed on Nov. 1, 2022, entitled “HIDEAWAY STEPS”, the entire disclosure of which is incorporated herein by reference.

### TECHNICAL FIELD

The embodiments generally relate to devices for pet comfort and mobility.

### BACKGROUND

Pets, much like humans, lose mobility as they age. Further, some pets may be too small or are otherwise physically compromised in their mobility. Existing pet comfort and mobility products are limited with respect to assisting pets onto furniture such as couches, sofas, chairs, beds, or the like. Step stools or rigid stairs may assist pets with climbing onto furniture, but such stools and stairs create clutter and a tripping hazard.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein disclose a hideaway stair assembly is disclosed, including a housing and a plurality of steps at least partially retained within the housing in a retracted configuration and the plurality of steps at least partially extended from the housing in an extended configuration. The plurality of steps are coupled to a shaft coupled to a flexible shaft coupling. A motor drives the shaft and moves the plurality of steps between the retracted configuration and the extended configuration to allow convenient access to a furniture item by a pet.

The disclosed hideaway steps may include a collapsible construction such that at least one stair tread may be hidden within the device or within furniture. For example, the disclosed hideaway steps may include a plurality of stair treads integrated with a piece of furniture and stowable within the furniture via a hand lever or similar device.

The disclosed hideaway steps satisfy an unmet need for a discrete, hide able, pet stair system that may be stand-alone or integrated with furniture.

In one aspect, the housing includes a top cover and may include a decorative cover to match or compliment the furniture item.

In one aspect, the motor is in electrical communication with a PCB board, wherein the PCB board is in electrical communication with a user interface.

In one aspect, the user interface includes a ON/OFF button and an IN/OUT button to selectively extend and retract the plurality of steps.

In one aspect, the housing includes a bottom, the bottom including a plurality of bases contacting a ground surface. Each of the plurality of bases may include an adhesive surface to grip the ground surface.

In one aspect, the bottom includes a plurality of wheels to facilitate movement of the apparatus.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the hideaway stair apparatus, according to some embodiments; and

FIG. 2 illustrates a front elevation view of the hideaway stair apparatus, according to some embodiments;

FIG. 3 illustrates a right side elevation view of the hideaway stair apparatus, according to some embodiments;

FIG. 4 illustrates a rear elevation view of the hideaway stair apparatus, according to some embodiments;

FIG. 5 illustrates a perspective view of the bottom of the hideaway stair apparatus, according to some embodiments;

FIG. 6 illustrates a perspective view of the top of the hideaway stair apparatus having the steps in an extended configuration, according to some embodiments;

FIG. 7 illustrates a side elevation view of the hideaway stair apparatus, according to some embodiments;

FIG. 8 illustrates a perspective view of the rear of the hideaway stair apparatus, according to some embodiments;

FIG. 9 illustrates a detail view of the rear of the hideaway stair apparatus including the mounting brackets and strain relief bussing, according to some embodiments;

FIG. 10 illustrates a detail view of the rear of the hideaway stair apparatus including the motor and Printed Circuit Board (PCB) controller, according to some embodiments;

FIG. 11 illustrates a detail view of the rear of the hideaway stair apparatus including the flexible shaft coupling, according to some embodiments;

FIG. 12 illustrates a detail view of the top of a drawer of the hideaway stair apparatus including the LED's, according to some embodiments;

FIG. 13 illustrates a detail view of the top of the first drawer of the hideaway stair apparatus including the shaft attached to the flexible shaft coupling, according to some embodiments;

FIG. 14 illustrates a perspective view of the first shelf of the hideaway stair apparatus, according to some embodiments;

FIG. 15 illustrates a perspective view of the second shelf of the hideaway stair apparatus, according to some embodiments;

FIG. 16 illustrates a perspective view of the third shelf of the hideaway stair apparatus, according to some embodiments;

FIG. 17 illustrates a perspective view of the drawer of the hideaway stair apparatus, according to some embodiments; and

FIG. 18 illustrates a perspective view of the hideaway stair apparatus, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a hideaway step apparatus (which may be referred to herein as “apparatus” or “the apparatus”) which can be utilized by pets to access furniture such as a chair, couch, bed, etc. The apparatus may be particularly useful for smaller pets or those who have impaired movement from aging, injury, or other causes.

In some embodiments, the hideaway steps may include a collapsible construction such that at least one stair tread may be hidden within the device or within furniture. For example, the disclosed hideaway steps may include a single stair tread and riser integrated with a piece of furniture and stowable within the furniture via a hand lever or similar device.

The disclosed hideaway steps may be built into a recliner or sofa, bed, or other furniture item and may include the same material as the sofa or recliner such as, but not limited to, leather, cloth, etc. One skilled in the arts will readily understand that various furniture types may be accommodated.

The disclosed hideaway steps may include at least one stair tread being generally flat to provide a surface onto which a pet may step or sit. The disclosed hideaway steps may include a plurality of stair treads foldable or collapsible within a standalone device or within a piece of furniture.

According to one embodiment, the disclosed hideaway steps may include a collapsible scissor frame constructed and arranged to fold ably collapse and extend to hide or reveal the stair treads. The disclosed hideaway steps may include a lever mechanism in operable communication with the scissor frame to facilitate the collapse or extension of the scissor frame. The disclosed hideaway steps may include a biasing mechanism in operable communication with the scissor frame and lever mechanism such that the hideaway steps may be biased into at least two positions i.e., a folded position or an extended position.

Stair treads may sit atop optional risers and may be connected to the frame. Each stair tread may have an over-hang lip or ledge. Lighting, such as LED lighting may be disposed underneath or atop each over-hang lip such that stair treads may be illuminated when extended. According to some embodiments, when the hideaway steps are in a folded or closed position, the lighting may be automatically turned off. Lighting may be power by an on-frame power source, such as a battery, or via an outlet plug-in.

The disclosed hideaway steps may be integrated into existing furniture, such as within a reclining couch having extendable leg supports and reclining back portion. The disclosed hideaway steps may be within the couch, possibly between adjacent seats within a reclining couch. The disclosed hideaway steps may be extendable from the couch via a lever mechanism integrated within the couch, similar to a reclining chair or couches recliner lever. Similarly, the disclosed hideaway steps' scissor frame may function similarly to the scissoring mechanism which supports the extension and retraction of a recliner's extendable leg supports.

According to other embodiments, the disclosed hideaway steps may be extendable via a mechanism other than a scissor frame such as utility slides, extendable poles or rods, or the like.

According to some embodiments, the various stair treads, and in particular the lowermost stair tread, may have wheels or casters, with corresponding support structure, such that the lowermost stair tread may maintain contact with the floor to provide structural support to the hideaway steps.

In this way, the disclosed hideaway steps may provide a means for stowing or extending a pet-centric stair system to allow for simple, comfortable means to assist pets with climbing onto furniture.

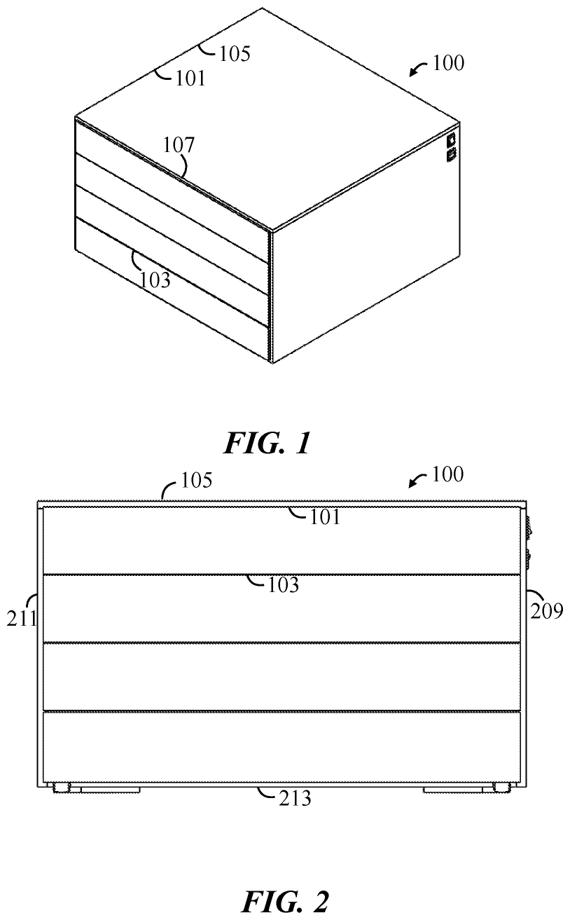

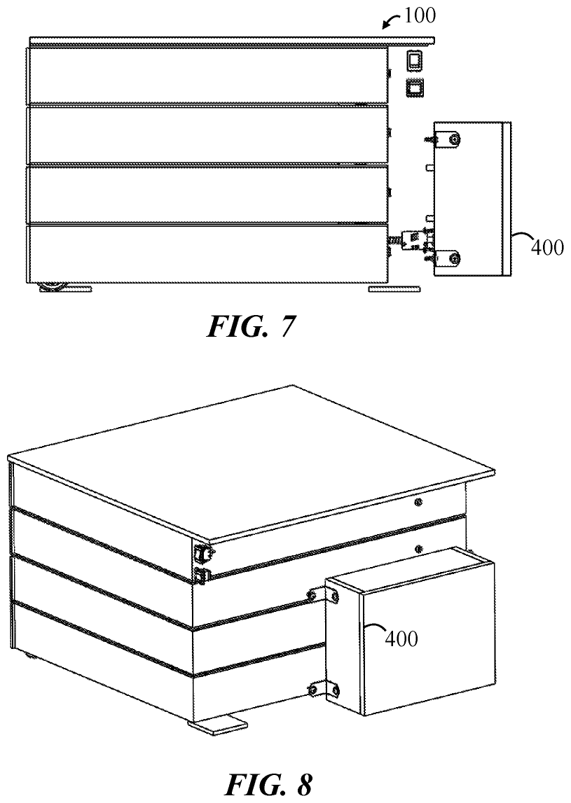

FIG. 1 illustrates a perspective view of the hideaway stair apparatus 100. The apparatus includes a housing 101 which at least partially contains the steps 103 when in a retracted configuration 104 as shown in FIG. 1. FIG. 6 illustrates the steps in an extended configuration 600. Referring back to FIG. 1, the housing 101 includes a top cover 105 forming a substantially flat surface and may be utilized as the final top step 107. The top cover 105 may be covered with a decorative material, such as a material which matches or compliments the furniture to which the apparatus is optionally attached to. One skilled in the arts will readily understand that the dimensions of the housing 101 may be changed to accommodate various sized of furniture. For example, a taller height of the housing 101 may be useful for a bed, while a shorter height of the housing 101 may best accommodate a lower couch or chair.

FIG. 2 illustrates a front elevation view of the hideaway stair apparatus 100. The steps 103 are contained between the right and left sidewalls 209,211 of the housing 101, as well as the top cover 105 and bottom 213. The housing 101 may include bases positioned on the bottom 213 which contact the ground surface and provide grip, thus ensuring the apparatus 100 does not move during use.

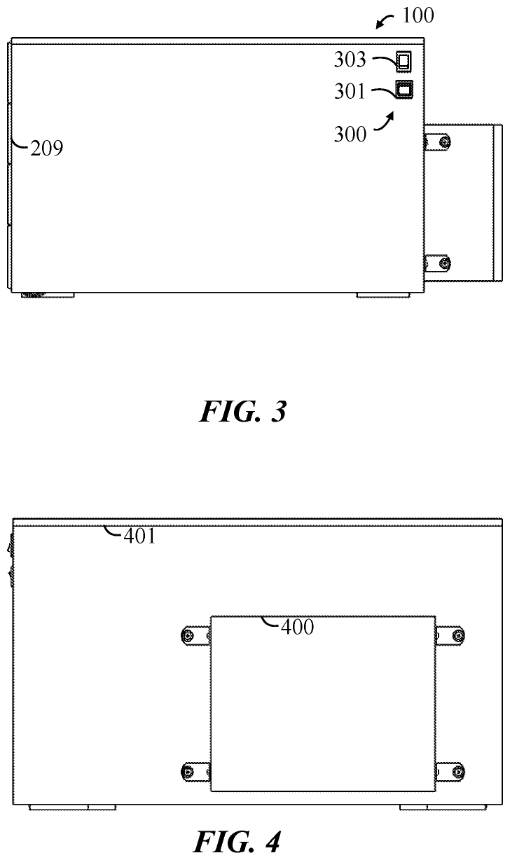

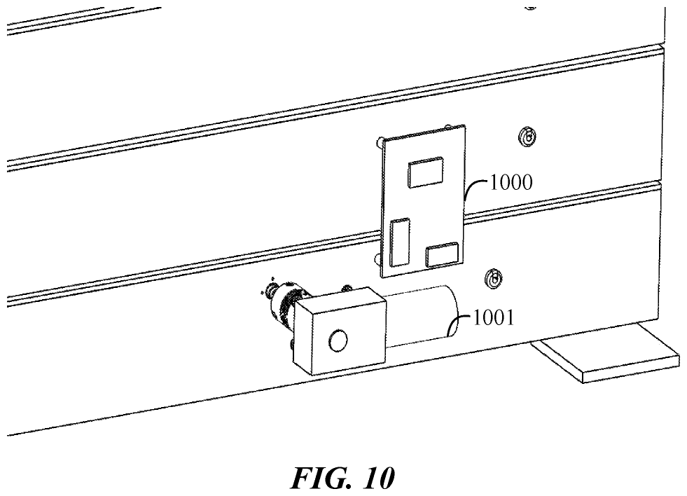

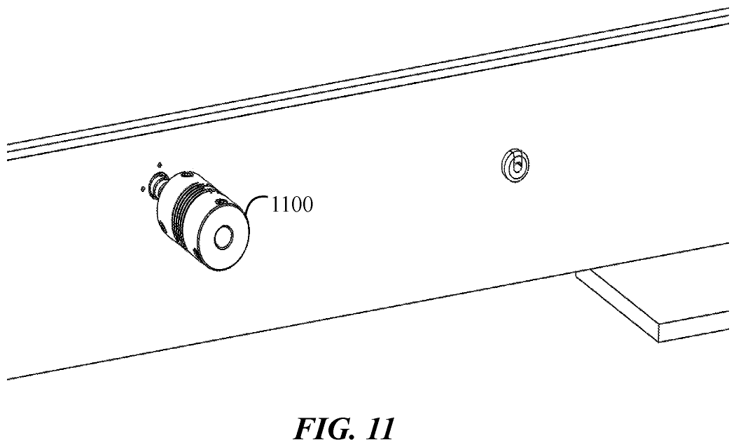

FIG. 3 illustrates a right side elevation view of the hideaway stair apparatus 100. The right sidewall 209 includes a user interface 300 which may include a power button 301 as well as a in/out button 303 to allow the user to selectively move the steps into and out of the extended and retracted configurations. The user interface 300 may be provided in various configurations such as a single button to control each function, or multiple buttons assigned to each functionality. As shown in FIG. 10, the user interface 300 is in electrical communication with a PCB 1000 and motor 1001 which are contained within a cover 400 (see FIG. 4) provided on the rear wall 401. The cover 400 may be removable to access the PCB 1000 and motor 1001.

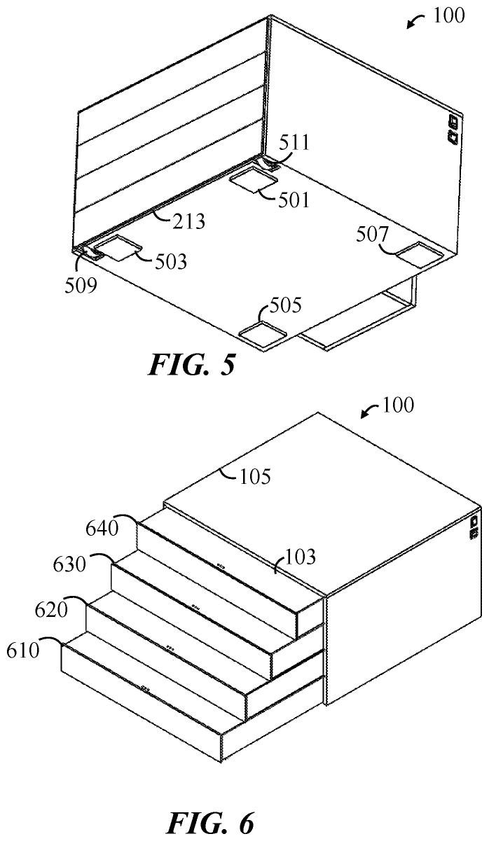

FIG. 5 illustrates a perspective view of the bottom 213 of the hideaway stair apparatus 100. Bases 501,503,505,507 are provided to contact the ground surface and provide grip to prevent unwanted movement of the apparatus 100. The bases 501,503,505,507 may include an adhesive surface. Wheels 509,511 may be provided to allow for easy movement of the apparatus 100.

FIG. 6 illustrates a perspective view of the top of the hideaway stair apparatus 100 having the steps in an extended configuration. In the illustrated example, the apparatus may include four steps 103 which provide a convenient means of stepping up to the top cover 105 and onto the furniture.

FIG. 7 illustrates a side elevation view of the hideaway stair apparatus 100 having the cover 400 partially extended from the rear of the housing. Meanwhile, FIG. 8 illustrates the cover 400 attached to the apparatus.

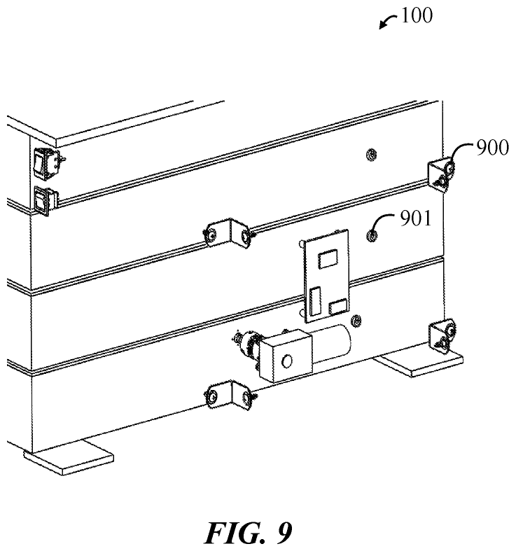

FIG. 9 illustrates a detail view of the rear of the hideaway stair apparatus 100 including the mounting brackets 900 and strain relief bussing 901. A plurality of mounting brackets (four in the illustrated example can be used to attach the cover.

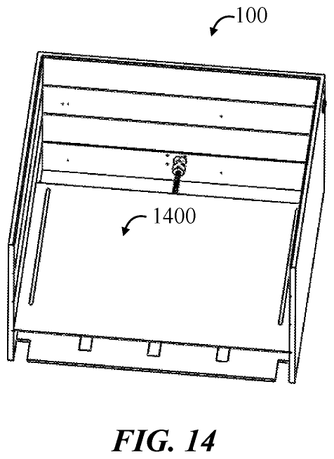

FIG. 11 illustrates a detail view of the rear of the hideaway stair apparatus including the flexible shaft coupling 1100. The flexible shaft coupling 1100 receives a shaft 1300 (see FIG. 13) and is connected to the motor to forcibly turn the shaft 1300 and extend the steps.

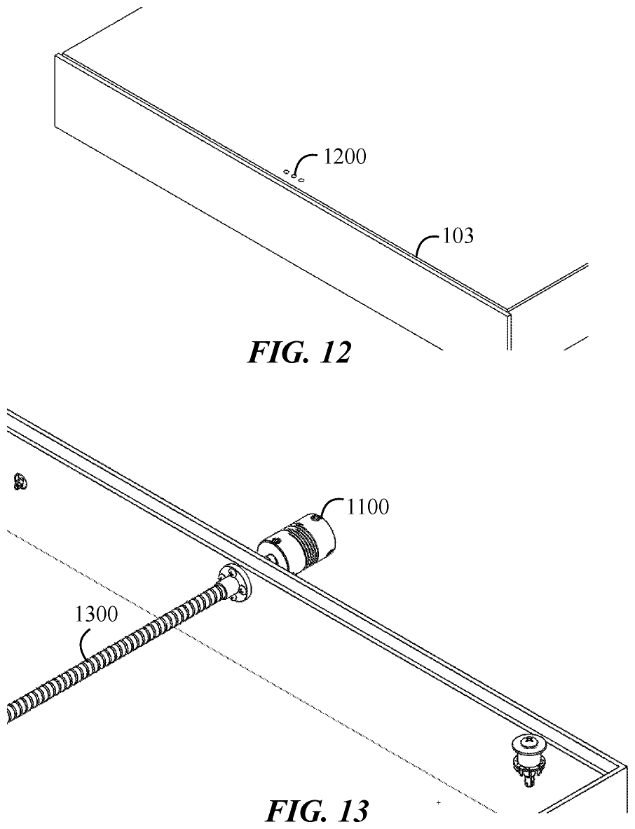

FIG. 12 illustrates a detail view of the top of a step 103 of the hideaway stair apparatus including the LED's 1200 which illuminate the steps when in an extended configuration. The LED's 1200 provide a safety feature as well as provide a means for illuminating the steps which may be useful for pets having impaired vision.

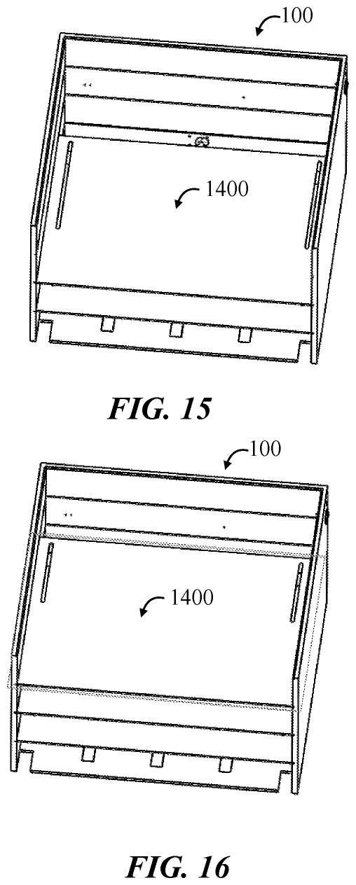

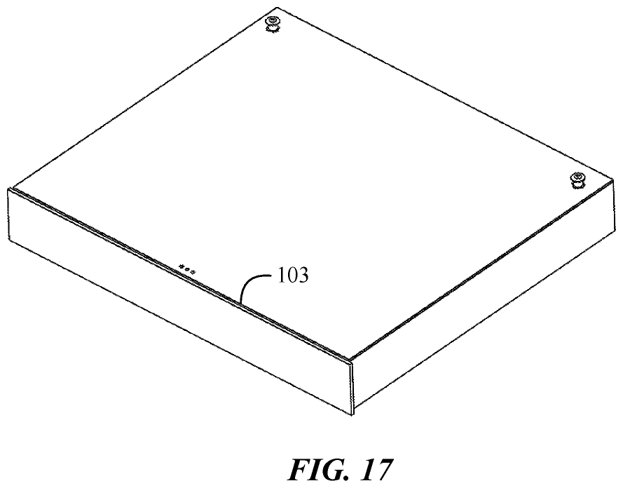

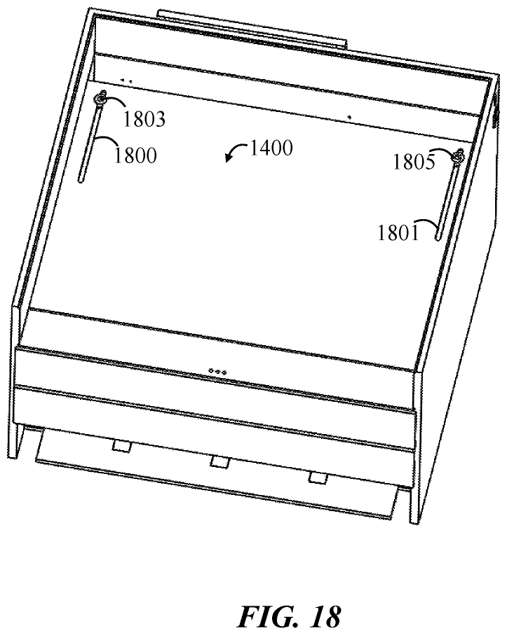

FIGS. 14-16 illustrates a perspective view of the interior 1400 of the hideaway stair apparatus 100 while illustrating each step contained therein. FIG. 17 illustrates a perspective view of a step 103 of the hideaway stair apparatus. The apparatus may contain a plurality of steps. The example illustrated herein, and most clearly in FIG. 6 illustrates four steps 610,620,630,640 (see FIG. 6) which allow for a convenient means of stepping up to the furniture item.

FIG. 18 illustrates a perspective view of the interior 1400 of the hideaway stair apparatus. Each step includes channels 1800,1801 to receive a rollers 1803,1805 to allow for the extension and retraction of each step.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A hideaway stair assembly, comprising:
a housing:
a plurality of steps at least partially retained within the housing in a retracted configuration and the plurality of steps at least partially extended from the housing in an extended configuration, the plurality of steps coupled to a shaft coupled to a flexible shaft coupling; and
a motor to drive the shaft and move the plurality of steps between the retracted configuration and the extended configuration, the housing to provide steps for conveniently accessing a furniture item.

2. The assembly of claim 1, wherein the housing includes a top cover.

3. The assembly of claim 1, wherein the housing is provided with a decorative cover to match or compliment the furniture item.

4. The assembly of claim 1, wherein the motor is in electrical communication with a PCB board.

5. The assembly of claim 4, wherein the PCB board is in electrical communication with a user interface.

6. The assembly of claim 5, wherein the user interface includes a ON/OFF button.

7. The assembly of claim 5, wherein user interface includes a IN/OUT button to selectively extend and retract the plurality of steps.

8. The assembly of claim 1, wherein the housing includes a bottom, the bottom including a plurality of bases contacting a ground surface.

9. The assembly of claim 8, wherein the plurality of bases include an adhesive surface.

10. The assembly of claim 8, wherein the bottom includes a plurality of wheels to facilitate movement of the apparatus.

11. A hideaway stair assembly, comprising:
a housing:
a plurality of steps at least partially retained within the housing in a retracted configuration and the plurality of steps at least partially extended from the housing in an extended configuration, the plurality of steps coupled to a shaft coupled to a flexible shaft coupling;
a motor to drive the shaft and move the plurality of steps between the retracted configuration and the extended configuration, the housing to provide steps for conveniently accessing a furniture item;
a PCB in electrical communication with the motor and a user interface to permit the selective extension and retraction of the plurality of steps; and
at least one LED provided on each of the plurality of steps.

12. The assembly of claim 11, wherein the housing includes a top cover.

13. The assembly of claim 11, wherein the housing is provided with a decorative cover to match or compliment the furniture item.

14. The assembly of claim 11, wherein the user interface includes a ON/OFF button.

15. The assembly of claim 11, wherein user interface includes a IN/OUT button to selectively extend and retract the plurality of steps.

16. The assembly of claim 11, wherein the housing includes a bottom, the bottom including a plurality of bases contacting a ground surface.

17. The assembly of claim 16, wherein the plurality of bases include an adhesive surface.

18. The assembly of claim 16, wherein the bottom includes a plurality of wheels to facilitate movement of the apparatus.

19. The assembly of claim 11, wherein each of the plurality of steps include one or more channels each accepting a roller to guide the extension and retraction of each of the plurality of steps.

20. A hideaway stair assembly, comprising:
a decorative housing:
a plurality of steps at least partially retained within the housing in a retracted configuration and the plurality of steps at least partially extended from the housing in an extended configuration, the plurality of steps coupled to a shaft coupled to a flexible shaft coupling;
a motor to drive the shaft and move the plurality of steps between the retracted configuration and the extended configuration, the housing to provide steps for conveniently accessing a furniture item;
at least one channel to each accept a roller to guide the extension and retraction of each of the plurality of steps;
a PCB in electrical communication with the motor and a user interface to permit the selective extension and retraction of the plurality of steps; and
at least one LED provided on each of the plurality of steps.
